(19) United States
(12) Patent Application Publication
(10) Pub. No.: US 2007/0274468 A1
(43) Pub. Date: Nov. 29, 2007

(54) Retrieval of voicemail

(75) Inventor: Yigang Cai, Naperville, IL (US)

Correspondence Address: Werner Ulrich, 434 Maple Street, Glen Ellyn, IL, 60137-3826, US

(73) Assignee: Lucent Technologies, Inc.

(21) Appl. No.: 11/432,710

(22) Filed: May 11, 2006

(51) Int. Cl. H04M 1/64

(52) U.S. Cl. 379/67.1

(57) ABSTRACT

This invention relates to a method and apparatus for permitting a voicemail customer to customize his/her playback of voicemail messages. The voicemail system stores a menu, specified by the customer, for regulating the order in which received calls are to be played back. Advantageously, the customer can specify an order that satisfies his/her needs.

### TECHNICAL FIELD

This invention relates to methods and apparatus for flexibly retrieving voicemail.

### BACKGROUND OF THE INVENTION

There are two primary methods for leaving messages for a telecommunications customer when that customer is not available. The customer may have an answering machine as part of his/her customer premises equipment or the customer may subscribe to voicemail, a service which records messages on a centralized basis in a switch serving the customer. The latter arrangement offers the major advantage of allowing a terminating customer to receive messages from two or more simultaneous callers. Further, voicemail can be used to receive facsimile messages and text messages as well as voice messages. In the future, video messages are also likely to be received and then sent to the customer.

A problem of the prior art is that the present voicemail arrangements have limited flexibility in permitting the customer to retrieve stored messages.

### SUMMARY OF THE INVENTION

Applicant has carefully studied the available options provided by existing voicemail systems and has concluded that a major flaw is that the customer cannot control the order of the playback of messages. For example, if a customer has gone on a long vacation and returns to find hundreds of messages, the customer may be initially interested only in the messages from the family. The present arrangement does not permit the customer to request only those messages.

In accordance with Applicant's invention, which is a contribution over the teachings of the prior art, a customer can specify a menu describing an ordering of messages to be played to the customer; the ordering can be by selected incoming telephone numbers (for example, corresponding to members of the family); geographic location of the source of the message (local, long distance, international); call type (voice, fax, text); calling time interval (today, yesterday, last week, last month); time order (most recent first, most recent last). The menu describing the order of playback of messages can be stored on a permanent basis and, for special situations, can be altered on a temporary basis. This menu controls the ordering of the playback of messages to the called customer.

In accordance with one feature of Applicant's invention, the voicemail system can categorize messages according to any of the criteria specified above, and the customer can specify which category of messages are to be delivered first.

### BRIEF DESCRIPTION OF THE DRAWINGS

FIG. 1 is a block diagram illustrating the operation of Applicants' invention;

FIG. 2 is a flow diagram illustrating the process accessing stored voicemail messages; and

FIG. 3 is a flow diagram illustrating the process of changing a customer's menu.

### DETAILED DESCRIPTION

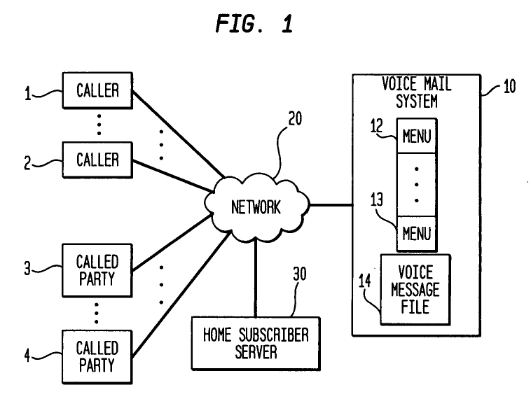

FIG. 1 is a block diagram illustrating the operation of Applicants' invention. Callers 1, . . . , 2 leave voicemail messages for called party 3. The voicemail messages are routed through network 20 to a voicemail system 10 where they are stored in file 14. Voicemail system 10 also stores menus 12, . . . , 13 for each called party 3, . . . , 4 subscribing to the selective access service. When the called party 3 requests messages from the voicemail system, the voicemail system accesses one of the menus 12, . . . , 13, the menu for called party 3, and uses this menu to order the calls that will be played back to the called party. The menu will specify an ordering of the replay of messages (it could be hierarchy menu). If a message played back is deemed less important, a called party can signal by keying one or more dual tone multifrequency buttons such as the # button to have the message deferred for subsequent delivery or to have the message deleted. After each message has been played, the called party can choose to delete the message; otherwise the message will be retained. The skip or delete function is known in the prior art.

Messages that are marked as being high priority will be delivered first unless the called customer requests that priority be ignored. Priority will be indicated through signals keyed by the caller when making the call. Priority can only be indicated by callers who have the personal identification number of the called party. The priority is provisioned through a profile which stored in the voicemail system and can be updated by the subscriber. The voicemail retrieve logic will call the function of the profile and present the voice message to the subscriber in the right order and hierarchy as defined in the profile.

In accordance with one preferred embodiment, the called party can order the factors to be considered so that one called party may request that the first calls to be played are calls from family members, a manager, or relatives and friends as specified by a list of calling numbers, whereas another called party may request that international calls be transmitted first.

The categories specified in this preferred embodiment include: originating party priority (a list of telephone numbers of, for example, family members, managers, relatives or friends); originating party type (international, long distance, local); call type (voice, fax, text); date and time of the call (today, yesterday, last week). The category need not be exhaustive. For example, a customer may request that international calls be given priority but that originating party priority be placed ahead of long distance and local calls. Remaining messages can be requested in calling time order, either from newest to oldest, or from oldest to newest.

In accordance with one feature of Applicant's invention, the called party can modify the menu temporarily or permanently. The called party accesses a home subscriber server 30 to control such changes.

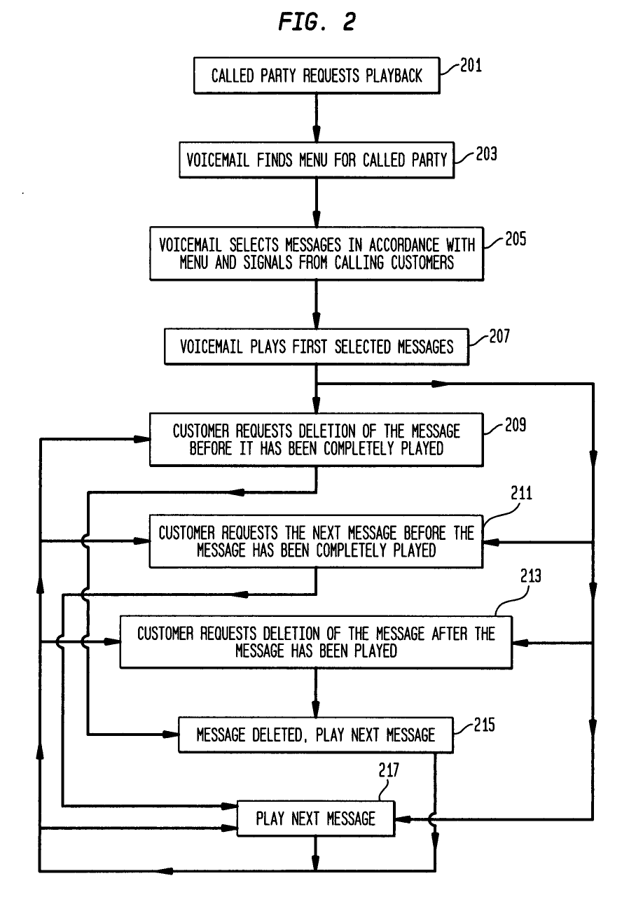

FIG. 2 is a flowchart illustrating the operation of playing back stored calls. The called party requests a playback (action block 201). The voicemail system finds the menu (described in a priority profile of subscriber) for the called party customer (action block 203). The voicemail system then selects messages in accordance with the menu (action block 205). The voicemail system then plays the selected messages in the order of selection (action block 207). During playback, the customer may delete an incompletely played message (action block 209) or skip to the next message without deleting (action block 211). After a message has been played, the customer can specify deletion of the message (action block 213) and then go on to the next message (action block 215); or the system simply goes on to play the next message (action block 217). The customer can access one message type (folder or subdirectory) then move to another one or exit.

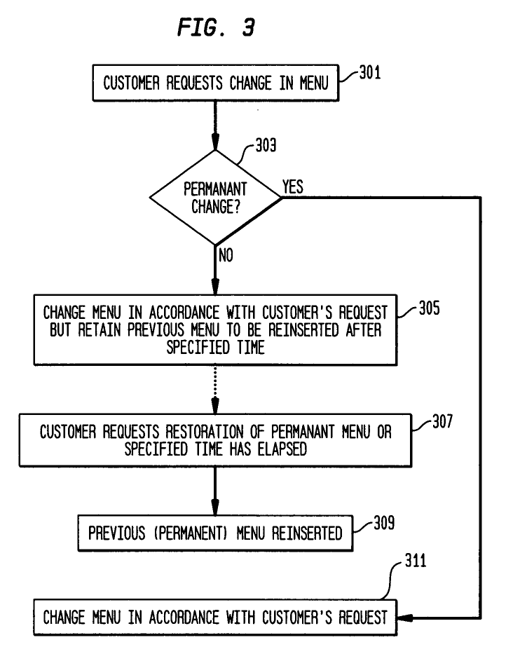

FIG. 3 illustrates the process of controlling the menu for a particular called party. The customer requests a change in the menu (action block 301). The request is either permanent or temporary. Test 303 determines whether the request is for a permanent change. If the request is for a permanent change, then the menu is changes (action block 311). If the change is temporary, then the menu is changed but the permanent copy of the menu is retained (action block 305). Subsequently, when the customer requests a return to the permanent menu (action block 307), the permanent menu is restored (action block 309). The time/duration of temporary menu is also specified, so that when the time expires the system automatically returns to permanent menu. Even the permanent menu which is based on the priority profile is provisionable. The subscriber can access and provision the profile by interactive voice response (IVR) or Web browser, via, for example, the home subscriber server 30.

The above description is of one preferred embodiment of Applicant's invention. Other embodiments will be apparent to those of ordinary skill in the art. The invention is limited only by the attached claims.

I claim:

1. A method of accessing stored voicemail messages, comprising the steps of:
storing a menu for a customer, said menu specified by said customer;
storing messages for said customer;
responsive to a request by said customer to play stored voicemail messages, playing said voicemail messages in an order specified by said menu;
whereby a customer can access stored voicemail messages in a priority order specified by said menu.

2. The method of claim 1 wherein said menu comprises at least one list of telephone numbers.

3. The method of claim 1 wherein said menu specifies at least one set of geographically related telephone numbers.

4. The method of claim 1 wherein said menu specifies at least one set of messages of a call type.

5. The method of claim 1 wherein said menu specifies calls received in a specified time interval.

6. The method of claim 1 wherein said menu specifies that recorded calls should be played in reverse order of reception.

7. The method of claim 1 further comprising the step of:
modifying contents of said menu under control of said customer.

8. Apparatus for accessing stored voicemail messages, comprising:
means for storing a menu for a customer, said menu specified by said customer;
means for storing messages for said customer;
means, responsive to a request by said customer for playing stored voicemail messages, for playing said voicemail messages in an order specified by said menu;
whereby a customer can access stored voicemail messages in a priority order specified by said menu.

9. The apparatus of claim 8 wherein said menu comprises at least one list of telephone numbers.

10. The apparatus of claim 8 wherein said menu specifies at least one set of geographically related telephone numbers.

11. The apparatus of claim 8 wherein said menu specifies at least one set of messages of a call type.

12. The apparatus of claim 8 wherein said menu specifies calls received in a specified time interval.

13. The apparatus of claim 8 wherein said menu specifies that recorded calls should be played in reverse order of reception.

14. The apparatus of claim 8 further comprising:
means, controlled by said customer, for modifying contents of said menu.
